(19) United States
(12) Patent Application Publication
(10) Pub. No.: US 2011/0210986 A1
(43) Pub. Date: Sep. 1, 2011

(54) SYSTEMS AND METHODS FOR DETERMINING POSITIONING AND SIZING OF GRAPHICAL ELEMENTS

(76) Inventors: Stoitcho Goutsev, Toronto (CA); Troy A. Marchand, Nobleton (CA)

(21) Appl. No.: 12/897,450

(22) Filed: Oct. 4, 2010

Related U.S. Application Data
(60) Provisional application No. 61/309,224, filed on Mar. 1, 2010.

(51) Int. Cl. G09G 5/00

(52) U.S. Cl. 345/672

(57) ABSTRACT

One aspect of the technology described herein relates to a configuration system for determining positioning and relative sizing of at least one graphical element to be rendered on a canvas portion of a display, with the at least one graphical element having a plurality of element borders. The configuration system comprises: a plurality of guidelines which are fixed relative to the canvas portion; and a first fixed link of a fixed number of measurement units in length linking a first element border to a first guideline of the plurality of guidelines. Upon the reconfiguration of the canvas portion, the system may be configured to determine the position of the element borders. In doing so, the system may need to reposition the first guideline. The guidelines may be horizontal or vertical oriented. In some embodiments, at least one horizontal guideline may be placed at a point corresponding to a fixed fraction of the height of the canvas portion; and at least one vertical guideline may be placed at a point corresponding to a fixed fraction of the width of the canvas portion. In other embodiments, the guidelines may include a border guideline fixed to a border of the canvas portion.

### PRIORITY

This application claims priority from U.S. provisional patent application No. 61/309,224, filed Mar. 1, 2010, which is incorporated by referenced herein in its entirety.

### TECHNICAL FIELD

The described embodiments relate generally to the positioning and sizing of graphical elements corresponding to key performance indicators on an executive dashboard.

### BACKGROUND

When using a graphical user interface for a software application, a common problem arises when the user interface is rendered on a resizable display surface, such as a user interface window. As the size of the display surface is changed by an end-user, the position and size of each of the graphical elements (e.g., labels, button controls, pie charts, gauges, maps or bar graphs) on the display surface may need to be updated in order to achieve or maintain an aesthetically pleasing but functional and intuitive organization.

Existing solutions to such problem have limitations. For example, one approach may be to leave the position and size of graphical elements unchanged as the display surface is resized, and instead, introduce scrollbars on an as-needed basis if the display surface is resized to a size that is smaller than can show the entirety of the user interface. Such solution results in an inconvenient experience for the user as it may require the user to take additional steps to access the user interface.

Another existing approach to the problem is to apply proportional scaling to the position and size of each graphical element as the display surface is resized, but maintain the original aspect ratio and relative position of each graphical element. Such solution may improve accessibility to the user interface, but may result in unattractive graphical elements for example because such elements may be stretched or compressed or otherwise rendered unintelligible.

To address the limitations present in the above two approaches, graphical user interface programmers may customize the positioning and sizing behavior of each graphical element on an individual basis by using a markup language or other high-level programming code. However, such customization requires knowledge of programming languages, and may be difficult to accomplish for individuals without such expertise.

The inventors have recognized a need for improved systems and methods for defining the positioning and sizing behavior of graphical elements individually on a design surface, and for implementing this behavior at display-time. The embodiments described herein may address in whole or in part some or all of the above-noted challenges.

### BRIEF DESCRIPTION OF THE DRAWINGS

Embodiments are described in further detail below, by way of example only, with reference to the accompanying drawings, in which:

FIG. 1 is a schematic diagram of one implementation of a positioning and sizing system for determining the configuration of graphical elements, in accordance with the present disclosure;

FIG. 2 is a schematic illustration of a user interface for designing a dashboard, in accordance with the present disclosure;

FIG. 3 is an example screen shot of the designer window of FIG. 2 shown in greater detail, in accordance with the present disclosure;

FIG. 4A is a schematic illustration of the canvas record before the canvas is resized, as may be stored in a graphical elements database, in accordance with the present disclosure;

FIG. 4B is a schematic illustration of the canvas record of FIG. 4A after the canvas portion of the display as shown in FIG. 13A has been resized by doubling the width and height of the canvas;

FIG. 4C is a schematic illustration of the canvas record of FIG. 4A after the canvas portion of the display as shown in FIG. 13A has been resized by doubling the height and increasing the width by 20 units;

FIG. 5 is a schematic illustration of example guideline records, in accordance with the present disclosure;

FIG. 6A is a schematic illustration of graphical element records for the text box, pie chart and bar chart graphical elements, as may be stored in a graphical elements database, in accordance with the present disclosure;

FIG. 6B is a schematic illustration of graphical element records as may be stored in a graphical elements database after the canvas portion of the display of FIG. 13A has been resized by doubling the width and the height of the canvas, in accordance with the present disclosure;

FIG. 6C is a schematic illustration of graphical element records as may be stored in a graphical elements database after the canvas portion of the display of FIG. 13A has been resized by doubling the height and increasing the width by 20 units, in accordance with the present disclosure;

FIG. 7 is a flowchart illustrating the steps in a method of linking a graphical element border to a guideline, in accordance with the present disclosure;

FIG. 8 is an example screen shot showing the placement of fixed border guidelines and user-created guidelines in a designer window, in accordance with the present disclosure;

FIG. 9 is an example screen shot of a designer window illustrating example graphical elements on a canvas portion of a display, the bar chart graphical element being linked to guidelines, in accordance with the present disclosure;

FIG. 10 is an example screen shot of a pie chart graphical element being linked to guidelines, in accordance with the present disclosure;

FIG. 11 is an example screen shot of a text box graphical element showing a text box being linked to guidelines, in accordance with the present disclosure;

FIG. 12 is a flowchart illustrating the steps in a method of determining the position and size of a graphical element when a canvas is resized, in accordance with the present disclosure;

FIG. 13A is an example screen shot of a viewer window showing graphical elements on a canvas portion of a display as may be displayed on a dashboard, in accordance with the present disclosure;

FIG. 13B is a magnified view of a corner of the example screenshot in FIG. 13A, after it has been resized by doubling its width and height, in accordance with the present disclosure;

FIG. 13C is an example screen shot of a viewer window showing graphical elements on a canvas after the canvas portion of the display of FIG. 13A is resized by doubling the height and increasing the width by 20 units, in accordance with the present disclosure; and

FIG. 14 is a flowchart illustrating the steps in a method of determining the positioning and relative sizing of at least one graphical element to be rendered on a canvas portion of a display in one embodiment of the present disclosure.

### DETAILED DESCRIPTION

The embodiments described below relate generally to the design and operation of a graphical user interface in a software application. In some embodiments, the system may be a dashboard creation and management system that lets users interactively design and view data visualization dashboards. Dashboards may display graphical elements that contain visual representations of key performance indicators (KPI) for a business. KPIs may be business metrics that assist a business to better understand the data it has collected relating to the operation of the business.

Such a dashboard creation and management system may include two types of users: those who select the layout of a dashboard by placing KPIs on a dashboard (referred to generally below as “graphic designers”), or those interested in viewing the KPI data present on a completed dashboard design (referred to below generally as “business executives”).

The embodiments include the creation and use of guidelines, which can be placed anywhere on a canvas by a graphic designer. As will be discussed in greater detail below, graphical elements, for example, business charts and graphs, labels and button controls can be pinned (i.e., anchored) to guidelines with fixed offsets, which form a set of positioning and sizing constraints that the graphical elements must adhere to upon resizing of the corresponding display surface at display-time. This embodiment lets graphic designers custom tailor the positioning and sizing behavior of graphical elements individually, which would be difficult to achieve using a traditional layout approach alone. That is, the described embodiments facilitate a mixed layout system providing both absolute and relative positioning of graphical elements on a canvas.

The creation of guidelines and the pinning of graphical elements to guidelines is performed interactively by the graphic designer, without any need for custom markup or programming code. In some embodiments, guidelines may be configured to be only visible at design-time. Additionally, in some instances, guidelines corresponding to the border of the canvas may be generated automatically.

One aspect of the technology described herein relates to a configuration system for determining positioning and relative sizing of at least one graphical element to be rendered on a canvas portion of a display, with the at least one graphical element having a plurality of element borders. The configuration system comprises a plurality of guidelines which are fixed relative to the canvas portion; and a first fixed link of a fixed number of measurement units in length linking a first element border to a first guideline of the plurality of guidelines. Upon the reconfiguration of the canvas portion, the system may be configured to determine the position of the element borders. In doing so, the system may need to reposition the first guideline. When repositioning the first guideline, the absolute position of the first guideline may be altered while the relative position of the first guideline may remain unchanged.

The system may also be configured to communicate the position of the element borders to a drawing application configured to render the at least one graphical element.

The guidelines may be horizontally or vertically oriented. In some embodiments, at least one horizontal guideline may be placed at a point corresponding to a fixed fraction of the height of the canvas portion; and at least one vertical guideline may be placed at a point corresponding to a fixed fraction of the width of the canvas portion. Also, the guidelines may include a fixed border guideline fixed to a border of the canvas portion. In some scenarios, the border guidelines may be permanent.

By way of example, some of the graphical elements may be in the form of a text box, a label, a gauge, map, an image, a graph or a chart. Other figures or guidelines may be used.

The system may also include a graphical elements database configured to store graphical elements data corresponding to the at least one graphical element. The graphical elements data may include guideline data corresponding to the plurality of guidelines, and/or may contain key performance indicator data.

In some implementations, the configuration system may be incorporated in a drawing application.

A further aspect of the technology described herein relates to a method of determining positioning and relative sizing of at least one graphical element to be rendered on a canvas portion of a display, with the at least one graphical element having a plurality of element borders. The method may include: providing a plurality of guidelines which are fixed relative to the canvas portion, and providing a first fixed link of a fixed number of measurement units in length linking a first element border to the first guideline of the plurality of guidelines. The method may also include determining the position of the element borders upon receiving instructions corresponding to a reconfiguration of the canvas portion.

In some cases, this determining may include determining the position of the guidelines corresponding to the reconfiguration of the canvas portion. When determining the position of the guidelines, the absolute position of the guidelines may be altered while the relative positions of the guidelines may remain unchanged.

When determining the position of the first element border, the position can be configured to correspond to the first guideline and to the first fixed link.

The method may further include rendering the at least one graphical element.

When rendering, the method may also be configured to communicate the position of the element borders to a drawing application that is configured to render the at least one graphical element. By way of example, the at least one graphical element may be in the form of a text box, an image, a label, a gauge, a map, a graph, or a chart. Additionally, the graphical element may correspond to key performance indicator data.

In some embodiments, the guidelines may include a fixed border guideline fixed to a border of the canvas portion. The border guidelines may be permanent.

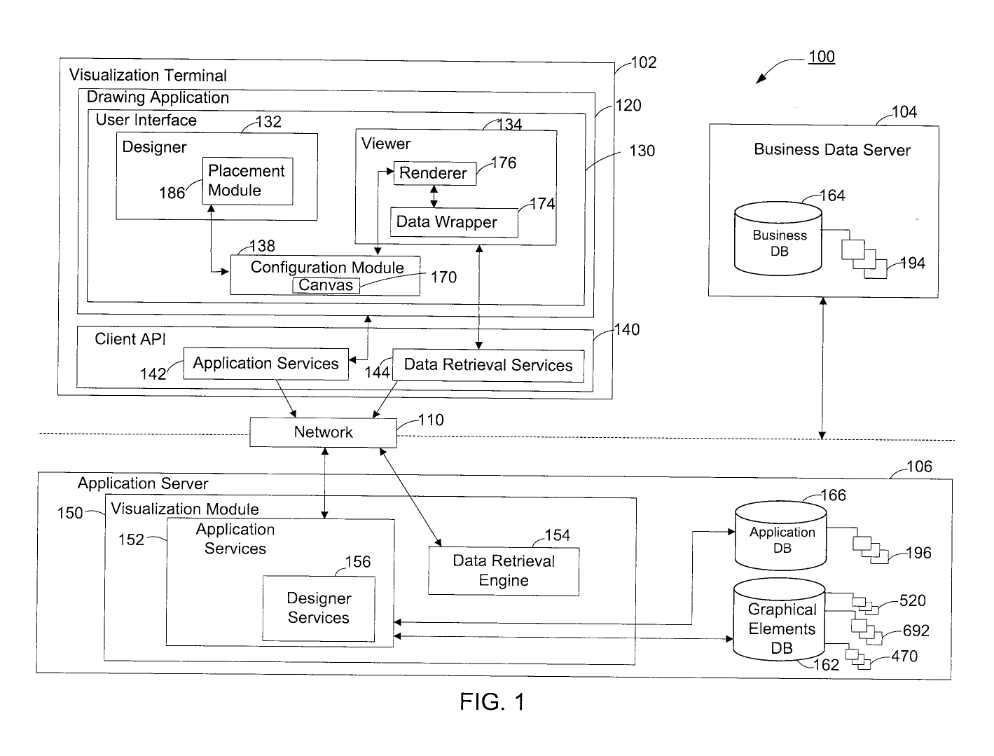

Referring to FIG. 1, illustrated there is a block diagram of one possible embodiment of a configuration system for determining positioning and relative sizing of graphical elements, shown generally as 100. The system may include one or more visualization terminals 102, a business data server 104 and an application server 106. Each of these components may be connected to a network 110 and be operable to communicate with each other.

Exemplary visualization terminal 102, business data server 104 and application server 106 comprise a number of components, including microprocessors. Microprocessors typically control the overall operation of computer systems. Microprocessors interact with additional subcomponents such as memory storage (which may include random access memory (RAM) and read-only memory (ROM), and persistent storage such as flash memory), display, network adapter and input device(s), for example, such as a keyboard, mouse, touchscreen (which may form part of the display) or touchpad. Network adapters allow connection to different types of networks (for example, Local Area Networks (LANs) as well as Wide Area Networks (WANs)), and may be wired (for example, through an Ethernet connection) or wireless (for example, through 802.11 Wireless Local Area Network (WLAN) or cellular standards). Operating system software used by a microprocessor is typically stored in a persistent store such as flash memory or read-only memory (ROM) or similar storage. Those skilled in the art will appreciate that the operating system, specific software components, or parts thereof, may be temporarily loaded into a volatile store such as RAM. Microprocessors, in addition to operating system functions, enable execution of software components. In the exemplary embodiment in FIG. 1, visualization terminal 102 executes drawing application 120, whereas application server 106 executes visualization module 150. Business Data server 104 executes software components (not shown) that provide access to business database 164.

From a high level perspective, application server 106 provides functionality to the visualization terminal 102 running drawing application 120 through network 110. In this way, the visualization terminal 102 may be considered a client computer in the client-server software architecture known in the art. While not illustrated, it will be understood that one or more visualization terminals 102 may be provided to access the functionality provided by application server 106. Such visualization terminals 102 may be used sequentially or in parallel to access the functionality of the application server 106 described below.

Business data server 104 may include business database 164 storing business data 194. Such business data 194 may correspond to any data stored by a business organization in relation to the operation of its business. For example, this may include transactional sales data or inventory data. In one embodiment, the drawing application 120 may include a dashboard creation and management system for creating and managing executive business dashboards that show business metrics, typically in a graphical format. Such business metrics for the example dashboard creation and management system may be derived from the business data 194. Application server 106 may take the business data 194, and organize/present it to business executives using visualization terminal 102.

The drawing application 120 (which can be a drawing-type design application or a user interface design application) may include a user interface 130. In some embodiments, the user interface 130 may be provided through a native standalone application running on visualization terminal 102. In other embodiments, the user interface 130 may be provided through a web browser. Various technologies are known in the art for providing user interfaces in a web browser. For example, such user interfaces 130 may be provided through web browsers enabled with Microsoft® Silverlight™ or Adobe® Flash®. As will be described in greater detail below, components within the user interface 130 can allow graphic designers to place and view graphical components on a canvas portion 170 of a display. During such process, the client API 140 will be accessed to provide the desired services from application server 106.

The client API 140 may be used for connecting to the remote software services provided by application server 106. These APIs may provide access to the client services that correspond with the services available on application server 106. The components of the client API 140 act to ensure that the services desired to be used on application server 106 are accessed through network 110, without requiring user interface 130 to know about the details of how to connect to another computer over the network 110.

Application server 106 may contain a visualization module 150, an application database 166 and a graphical elements database 162. In some embodiments, the visualization module 150 may include or be in the form of the server-side components of a dashboard creation and management system for use in accessing and visualizing business data 194 in the business database 164. Such components may include, for example, services for organizing the business data 194 on business database 164 into key performance indicators (KPIs). In some embodiments, such KPIs may correspond to the graphical elements shown in user interface 130 of the drawing application 120.

Application database 166 may be used for storing information related to software services made available by application server 106. For example, this may include storing application records 196 related to the definition of KPIs that map business data 194 on business database 164 to graphical elements that are to be displayed.

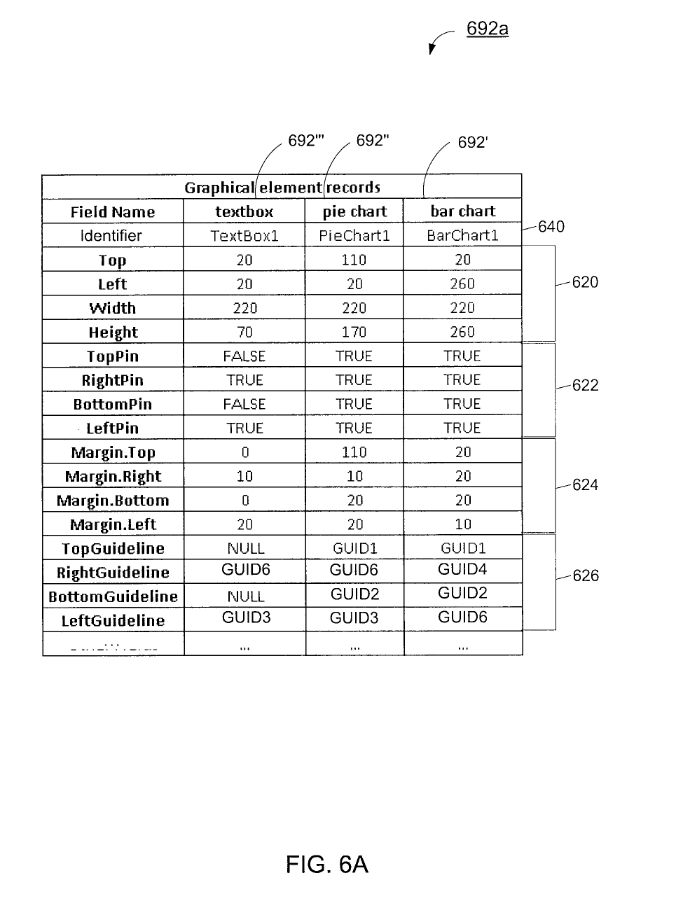

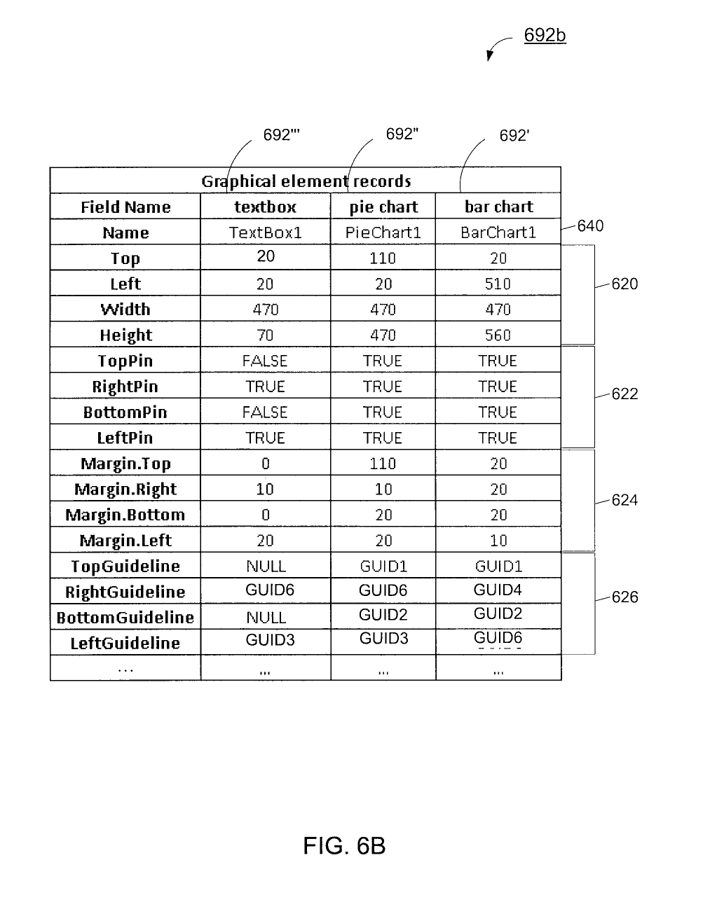

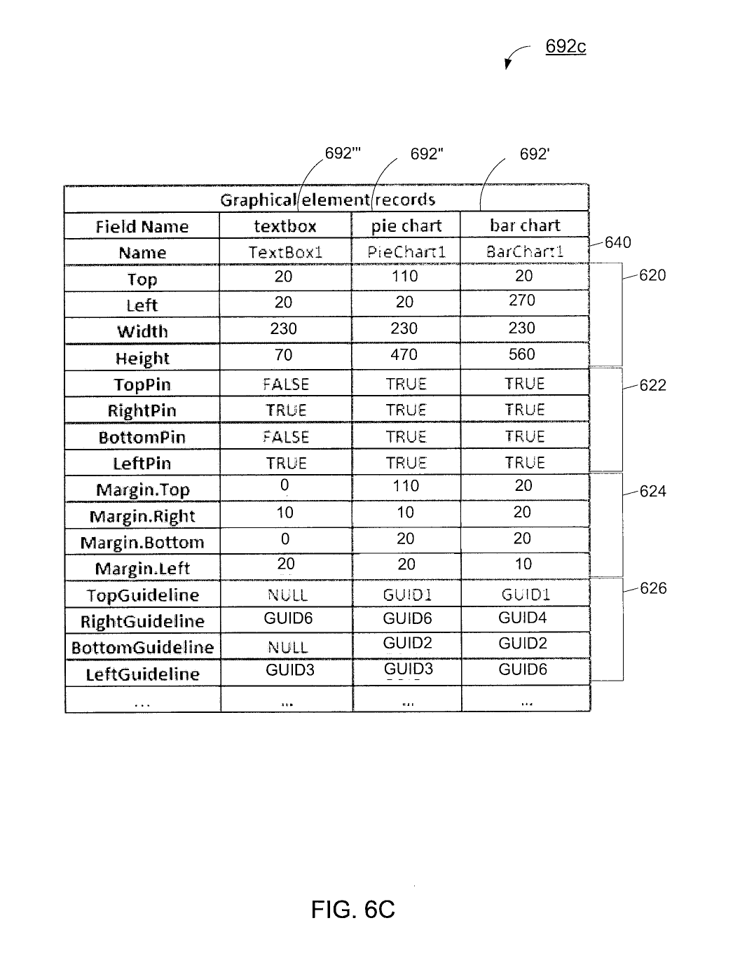

Graphical elements database 162 may be used for storing information related to the visualization of data performed in drawing application 120 on visualization terminal 102. For example, the graphical elements database 162 may contain graphical elements data store as records 692 relating to graphical element 192, e.g., for indicating their position and size. Referring briefly to FIG. 6A, shown there are examples of graphical element records 692a for a text box 692″, a pie chart 692″ and a bar chart 692′. It will be understood that many other different types of visualizations may be used for graphical elements 192, and that the examples provided are not meant to be limiting. For example, other graphical elements may include a label, a gauge or a map.

It will be understood that while the term databases are illustrated and used in the present disclosure, any suitable method of persistent storage (e.g., a fixed format file system) may be used in the role of the illustrated databases. It will also be understood by a person skilled in the art that although each of the application database 166 and graphical elements database 162 are illustrated in FIG. 1 as separated databases, the application database 166 and the graphical elements database 162 can be stored together as separate tables or data elements within the same or multiple databases both locally and/or remotely.

It will also be understood that other system arrangements may be possible. For example, application database 166 and/or graphical elements database 162 may reside on separate server computers, which may also be operatively connected to a network 110. In such configuration, application server 106 may communicate with such databases via the network 110 through their respective servers. In another embodiment, application server 106 may also host the business database 164 containing the business data 194 to be visualized. In such embodiment, the customer database may also be included within application server 106.

The internal components of the drawing application 120 will now be discussed in greater detail. User interface 130 may further include a designer module 132 and a viewer module 134. These components allow a graphic designer to respectively place and view graphical elements on the user interface 130. Each of these may be operatively connected to a configuration module 138 for determining the position and size of graphical elements 192. User interface 130 may also contain other UI screens (not shown) for interacting with the user. These components of the user interface 130 may interact with the client API 140 to access software services available on the visualization module 150 of the application server 106.

It will be understood that in some embodiments, the drawing application 120 may be configured to include client API 140 so that it forms part of the overall drawing application 120. However, in other embodiments, and as illustrated, the client API 140 may consist of a separate executable, library or DLL that is available on visualization terminal 102.

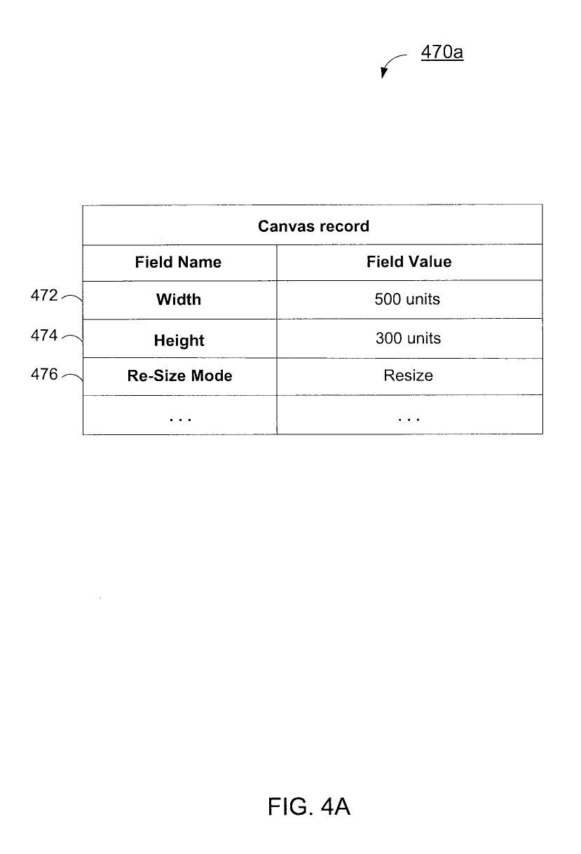

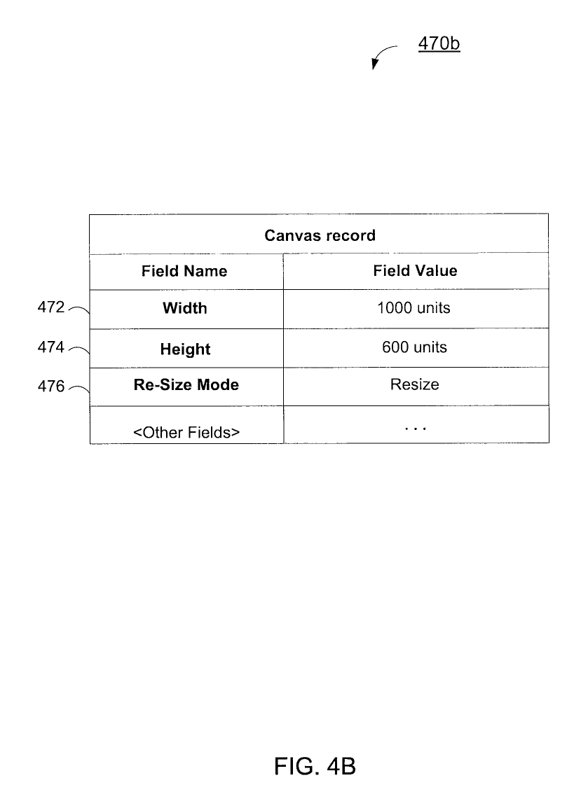

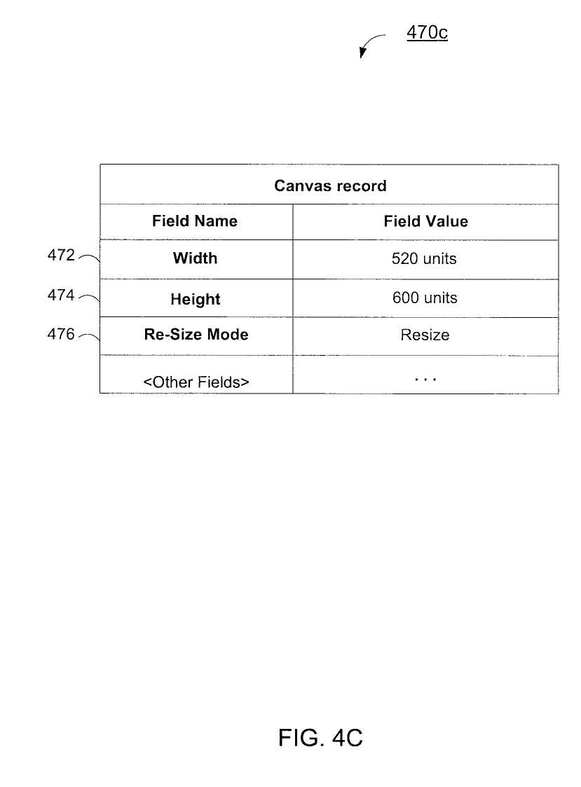

The configuration module 138 may regulate the operation of a canvas 170 on which graphical elements 192 may be placed. Referring briefly to FIG. 4A, shown there is an example canvas record 470 that may be also be stored in the graphical elements database 162 of application server 106. The designer module 132 and the viewer module 134 refers to the canvas 170 in their operation. That is, the canvas 170 provides a surface on which the graphical elements 192 may be positioned, and the canvas 170 may be resized for example to allow a business executive to customize their viewing surface when viewing a completed dashboard. As will be discussed in greater detail below, the graphical elements 192 may respond to such resizing by adjusting their appearance in accordance with whether some of their borders are linked to guidelines. That is, when a canvas 170 is resized by either the designer module 132 or the viewer module 134, the configuration module 138 is operable to recalculate the new position and size of the graphical elements 192 that are on the canvas 170.

Designer module 132 includes a placement module 186 for allowing a user to place or modify the position and size of graphical elements 192 on the canvas 170. The placement module 186 may handle user interactivity with respect to the placement of guidelines 320 on the canvas 170 and the linking of the borders of graphical elements 192 to guidelines 320 (described below).

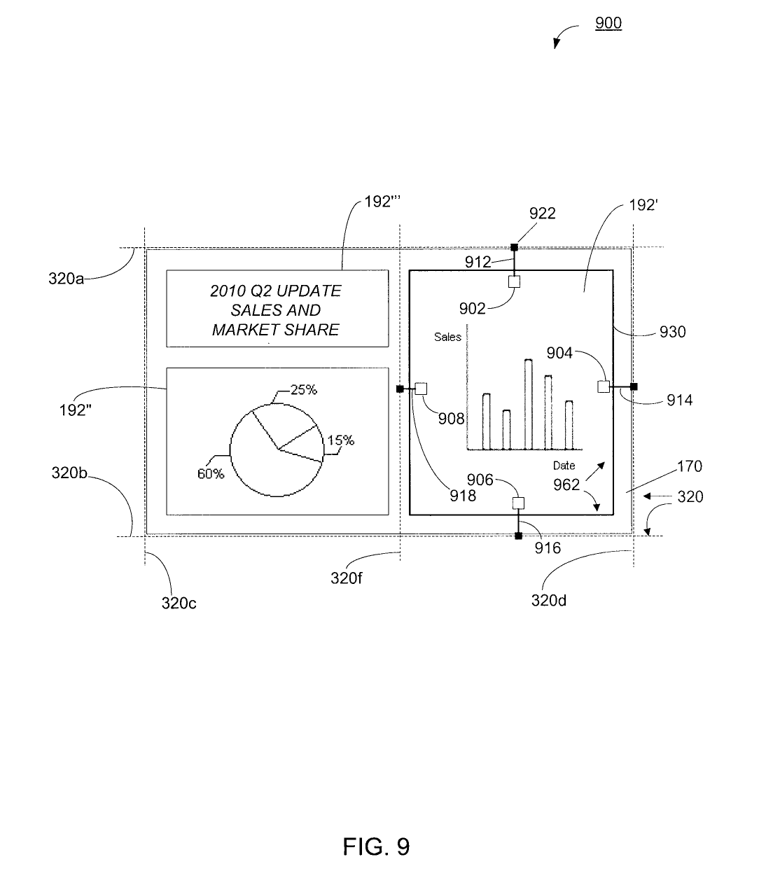

Viewer module 134 can perform the function of displaying a completed dashboard design to a business executive. The module may include a renderer 176 and a data wrapper 174. The renderer 176 communicates with the canvas 170 in the configuration module 138 to retrieve the graphical element records 692 that have been placed on the canvas 170 by a graphic designer using the designer module 132. Once retrieved, the renderer 176 can illustrate the graphical elements 192 on a display according to the position of the element borders 962 (as shown, e.g., in FIG. 9) in the graphical element records 692 (as shown, e.g., in FIG. 6A). When a graphical element 192 is displayed, the data wrapper 174 connects with the data retrieval services 144 to retrieve the business data 194 that is to be illustrated in the graphical element 192. Notably, if a canvas 170 is resized, the renderer 176 is operable to illustrate the graphical elements 192 on the canvas 170 after their position and size coordinates have been updated by the configuration module 138.

The internal components of the Client API 140 and the visualization module 150 will now be discussed together in greater detail. Client API 140 may further include application services 142 and data retrieval services 144. These services access their corresponding counterparts in the visualization module 150 of the application server 106: application services 152 and data retrieval engine 154 respectively. As noted, the client API 140 acts to insulate the drawing application 120 from needing to know about network access. As such, the application services 142 and the data retrieval services 144 in the client API 140 may be configured to send and receive messages to and from the visualization module 150 in the application server 106 according to known methods in the art. For example, this may involve the usage of communications protocols for ensuring the arrival of messages, the selection of message sizes, or the use of off-the-shelf programming techniques that encapsulate network communications (e.g., Simple Object Access Protocol).

Data retrieval services 144 on Client API 140 may be configured to provide access to remote software programs that have been programmed to perform the opening and closing of database connections, and the performance of queries on databases to retrieve data. When a request to perform a database operation is received by the drawing application 120, the data retrieval services 144 may be operable to send such message across network 110 to the visualization module 150.

The data retrieval engine 154 of the visualization module 150 may then be configured to receive the request message such that in response, the data retrieval engine 154 may be configured to connect to the business database 164 on business data server 104, perform the requested operation and relay the response back to the data retrieval services 144. In connecting to the business data server 104, the data retrieval engine 154 may send additional messages on the network 110 to the business data server 104.

Application services 142 on client API 140 may be configured to provide access to remote software services on the visualization module 150 that have been configured to perform operations associated with the visualization of the data. As noted, this may include services related to the definition of KPIs in regards to the business data 194 in the business database 164. Or, the services may be related to the designing or viewing of a dashboard in drawing application 120. With regard to the latter, and as is discussed in greater detail below, such functionality may include the retrieving and/or updating of the records 692, 520, 470 that are stored in the graphical elements database 162 when graphical elements 192 are moved and/or when a canvas 170 is resized.

When the application services 142 on client API 140 receives a request to perform an operation from drawing application 120, it sends the request message on network 110 to the visualization module 150 of the application server 106. The server-side application services 152 on visualization module 150 may be configured to receive such message and perform the operation by interacting with the application database 166 or the graphical elements database 162 as the case may be depending on the type of request. A response (e.g., if a graphical element record 692 was requested when viewing a designed dashboard) may then be sent by the server-side application services 152 back to the client-side application services 142, which may then relay the response back to the drawing application 120.

Designer services 156 is a subset of the available server-side application services 152, and provides remote software functionality to drawing application 120 related to the design of dashboard systems. Such services may include the selection and placement of graphical elements 192, and the linking of graphical element borders with guidelines (discussed below). The sending of messages from the drawing application 120 to the designer services 156 may follow a similar path as is described above with respect to the application services 142 and the service-side application services 152.

It will be appreciated by those skilled in the art that the functionality of the designer services 156 in application server 106 may be configured to be stored and executed (e.g., as a part of drawing application 120) on the visualization terminal 102. In such embodiment, the records 520, 692, 470 stored on the graphical elements database 162 may loaded into the memory of visualization terminal 102 by drawing application 120 such that the use of the designer module 132 in e.g., selecting and placing graphical elements 192 only modifies the in-memory records on visualization terminal 102. Further, such embodiment may be configured to only write the records 520, 692, 470 to the graphical elements database 162 when a user selects to save a modified dashboard design.

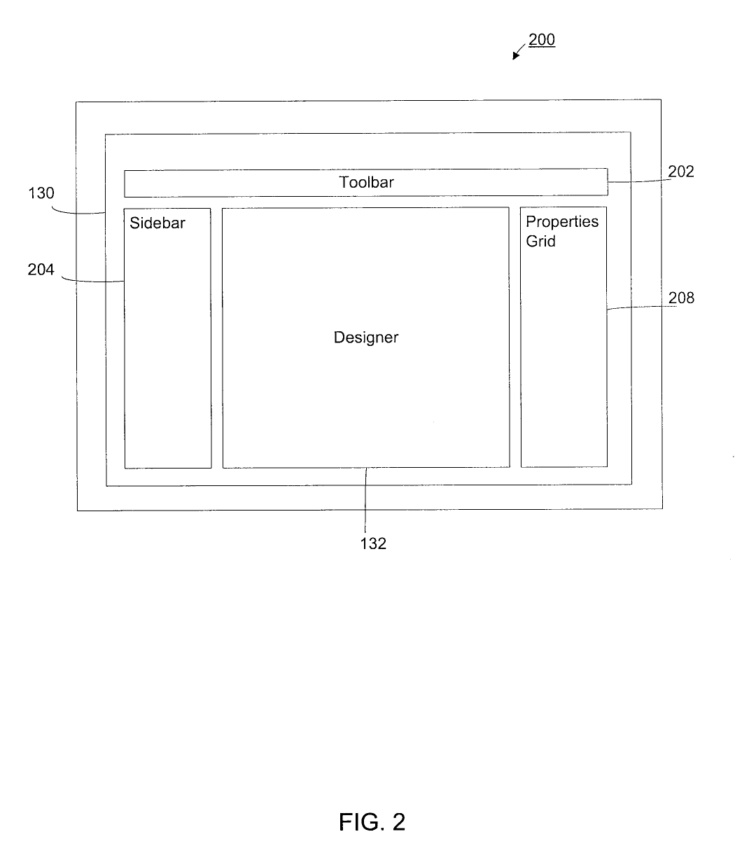

Referring to FIG. 2, illustrated there is a schematic diagram representing a user interface 130 inside a web browser on visualization terminal 102 for laying out data visualization graphical elements 192 on a dashboard, shown generally as 200. A designer window corresponding to designer module 132 may be provided on user interface 130 and may employ options provided on toolbar 202, sidebar 204 and the properties grid 208. Toolbar 202 provides a graphic designer with quick access to common operations, such as saving a modified dashboard design to the application database 166 and graphical elements database 162 from FIG. 1. A sidebar window 204 may provide access to a catalog of formatting elements such as data visualization controls, text boxes, and button controls. In one embodiment, graphic designers may, via drag-and-drop operations, select the formatting elements from the sidebar and add them to the designer window 132 for the purposes of laying out the graphical elements 192. That is, once a formatting element has been selected from the sidebar window 204 and placed on the designer window 132, it becomes a graphical element 192. A properties grid window 208 lets a graphic designer change the properties of a single graphical element 192 that is selected in the designer window of the designer module 132.

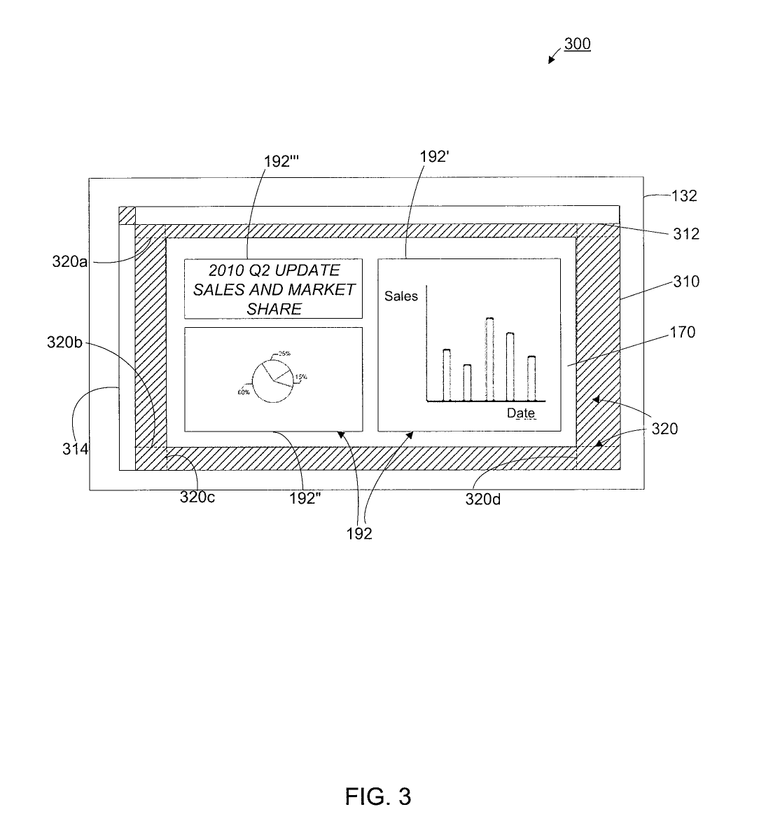

Referring to FIG. 3, an example screen shot, shown generally as 300, of the designer window provided by the designer module 132 is illustrated. Through this window, the designer module 132 shows a design surface 310 on the display that represents the available design space for composing the layout of graphical elements 192. A portion of the design surface 310 is designated for the canvas 170. The canvas 170 acts as the visible container for the content being designed. For example, the canvas 170 might represent a dashboard that is viewable when a business executive views a completed design on a canvas 170. In the description below, the terms “dashboard” will refer to the viewable graphical elements on a canvas 170 such that changes to canvas 170 (e.g., resizing) will impact the dashboard that is based off of the canvas 170.

Graphical elements 192 placed on the part of the design surface 310 that is not the canvas 170 are typically not viewable at display-time. A designer may want to use the non-viewable parts of the design surface 310 as a working area where the designer can maintain graphical elements that may represent “work in progress”, i.e., graphical elements 192 that require further work from the designer before they are ready to be shown to a business executive. Or, the display surface 310 may be used to store graphical elements 192 that are for different configurations of the viewable canvas 170.

Graphical elements 192 may be placed on the canvas 170. In the example, a text box 192′″, a bar chart 192′ and a pie chart 192″ have been placed on the canvas 170. When a canvas 170 and its associated graphical elements 192 are viewed, only the canvas 170 and the graphical elements 192, or the portions of graphical elements 192, appearing in the canvas 170 are visible at display-time. For example, if half of a graphical element 192 is positioned inside the area of the canvas 170 and its other half is outside of the canvas 170, only the half inside will be rendered initially at display-time.

Although the width and height of the canvas 170 can be configured by a designer at design-time through the use of the designer module 132, in one embodiment, its position is determined automatically so that it can be centered both horizontally and vertically on the design surface 310.

Referring to FIG. 4A, illustrated there is a schematic illustration of a canvas record, shown generally as 470a. Canvas record 470 may have three fields: width 472, height 474 and re-size mode 476. The record may be loaded into memory when the designer module 132 or viewer module 134 is in use. Canvas record 470 may also be stored in graphical elements database 162 when the layout in the designer module 132 is saved. Example canvas record 470a corresponds to canvas 170 shown in FIG. 3: the width field 472 is set to “500 units”, and the height value 474 is set to “300 units”. The Resize-Mode property 476 of the canvas 170 is set to “Resize”, which indicates that the positioning and sizing behavior of graphical elements 192 will be governed by the pinning of graphical elements 192 to guidelines 320 to accomplish the mixed absolute and relative repositioning of graphical elements 192, as is described in the present disclosure. Other possible values for the Resize-Mode property may include “None” (where the canvas 170 does not resize) and “Scale” (complete scaling of all graphical elements 192 with no ability to place fixed distances between graphical elements 192 and guidelines 320; in other words, a complete zoom effect). Neither of these options achieve the mixed absolute and relative position of graphical elements 192. The canvas record 470 may also have other fields, which may be unrelated to position and sizing.

As will be discussed in greater detail below, FIGS. 4B and 4C schematically illustrate the same canvas record illustrated in FIG. 4A, but at subsequent times, when the canvas 170 has been resized.

Referring back to FIG. 3, illustrated there on the designer window provided by the designer module 132 also are a plurality of fixed guidelines 320 fixed relative to the canvas 170, referred to generally as 320. Fixed border guidelines 320a, 320b, 320c, and 320d are fixed (or overlay or correspond to) to the borders of the canvas 170. In one embodiment, these four guidelines 320a, 320b, 320c, 320d are permanent and cannot be removed by the graphic designer. The purpose of guidelines 320 is to allow graphical element borders 962 to be linked to the guidelines 320 via a fixed link of a fixed number of measurement units in length. A graphic designer can create new guidelines 320 by initiating drag-and-drop operations from the rulers 312 and 314. The linking of borders of the graphical elements 192 can be done to any guideline 320, whether it is a border or a user-created guideline 320.

Guidelines 320 may have a vertical or a horizontal orientation. Vertical guidelines 320c, 320d may be configured to be parallel to a vertical border of the canvas 170, and horizontal guidelines 320a, 320b are parallel to a horizontal border of the canvas 170.

The position of a horizontal guideline 320 may be stored as a fixed fraction or a numerical percentage of the height of the canvas 170. That is, the distance between the placed horizontal guideline 320 and the top border of the canvas 170 may be a proportionate size of the entire height of the canvas 170 that corresponds to the percentage. When numerical percentages are used, a 0% percent position for a horizontal guideline would result in the horizontal guideline 320a that overlaps with the top border of the canvas 170. Similarly, a 100% horizontal guideline would result in the horizontal guideline 320b that overlaps with the bottom border of the canvas 170. A horizontal guideline at a position of 50% will always appear at half the height of the canvas 170, no matter how the canvas 170 is resized.

The length of a horizontal guideline e.g., 320a, 320b can extend beyond the canvas 170 and can be equal to the width of the design surface 310.

The position of a vertical guideline 320 may be stored as a fixed fraction or a numerical percentage of the width of the canvas 170. That is, the distance between the placed vertical guideline 320 and the left border of the canvas 170 may be the proportion of the entire width of the canvas 170 that corresponds to the percentage. When numerical percentages are used, a 0% vertical guideline would result in the vertical guideline 320c overlapping with the left border of the canvas 170, and a 100% vertical guideline 320d would result in the vertical guideline overlapping with the right border of the canvas 170. A vertical guideline at a position of 50% will always appear at half the width of the canvas 170, no matter how the canvas 170 is resized.

The length of a vertical guideline e.g., 320c, 320d can extend beyond the canvas 170 and can be equal to the height of the design surface 310.

Since the relative position of a guideline 320 remains unchanged no matter how the canvas 170 is resized, the position of the guideline 320 can be said to be fixed relative to the canvas 170.

User-created guidelines 320 may be placed anywhere on the design surface 310, even outside of the area of the canvas 170. In accordance with the above discussion regarding the storage of the placement position of guidelines 320 as percentages, a guideline 320 that is positioned outside of the canvas 170 can be said to have a position value that is either less than 0% (i.e., a negative value) or greater than 100%. That is, a vertical guideline 320 with a placement position of less than 0% would be placed to the left of the left border of the canvas 170, and a vertical guideline with a placement position of greater than 100% would be placed to the right of the right border of the canvas 170. Similarly, a horizontal guideline 320 with a placement position of less than 0% would be placed above the top border of the canvas 170, and a horizontal guideline with a placement position of greater than 100% would be placed below the bottom border of the canvas 170.

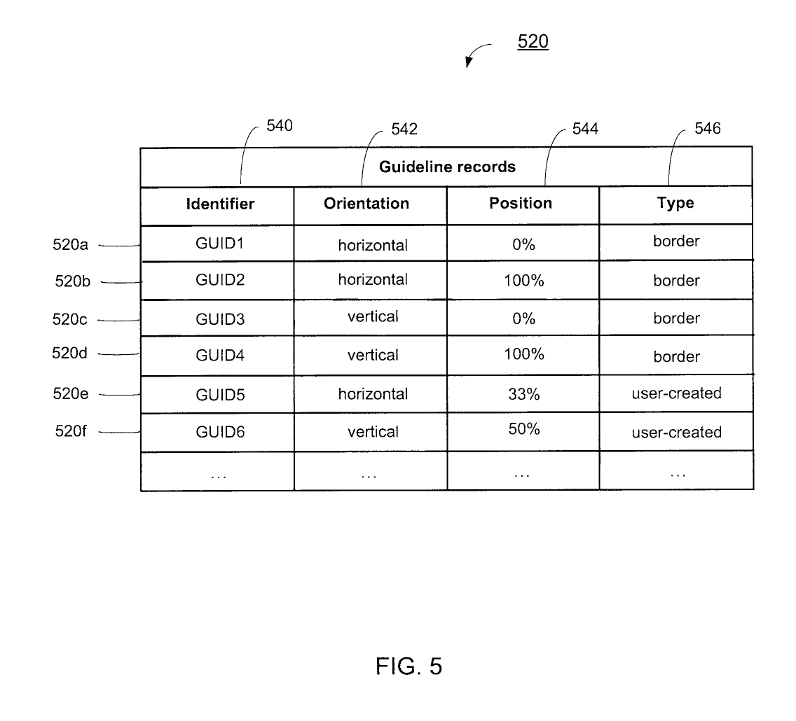

Referring again briefly to FIG. 1, when placing user-created guidelines 320e, 320f, the placement module 186 of the designer module 132 receives input from a graphic designer and sends a message to the configuration module 138 to register the location and orientation of a desired guideline 320. The configuration module 138 then sends a message to the visualization module 150 of application server 106 through application services 142 in client API 140. The designer services 156 in visualization module 150 receives this message and proceeds to store a corresponding guideline record 520 (shown in FIG. 5) in graphical elements database 162.

Referring simultaneously also to FIG. 5, illustrated there is a schematic illustration of example guideline data stored as guideline records, shown generally as 520, corresponding to the guidelines 320 shown in FIG. 3. Guideline records 520 may have 4 fields of data: an identifier 540, a guideline orientation 542, a position 544 and a guideline type 546. Such records 520 may be loaded into the memory of visualization terminal 102, and be dynamically updated to reflect changes in the dashboard design when the designer module 132 is being operated by a graphic designer, i.e., as the graphic designer is modifying the position of a guideline 320. These records 520 may be stored in graphical elements database 162 as the guidelines 320 are placed on the canvas 170, or, as discussed above, such saving may be performed only when a dashboard layout is saved.

Guideline records 520a, 520b, 520c and 520d correspond respectively to the guidelines 320a, 320b, 320c and 320d in FIG. 3. Each of the guideline records 520a, 520b, 520c, 520d has a unique identifier: GUID1, GUID2, GUID3 and GUID4 respectively. Examining the orientation fields 542 for these four guideline records, records 520a, 520b show that their corresponding guidelines 320a, 320b have a “horizontal” orientation, while the records 520c, 520d show that their corresponding guidelines 320c, 320d have a “vertical” orientation. Also, as described, the position fields 544 show the percentage positions of the corresponding guidelines 320: records 520a and 520b corresponding to the top (“0%”) and bottom (“100%”) horizontal guidelines 320a and 320b, and records 520c and 520d corresponding to the left (“0%”) and right (“100%”) vertical guidelines 320c and 320d. Since these four guidelines are default border guidelines, the type field 546 indicates that they are of the “border” type.

The type field 546 also shows two additional “user-created” guideline records 520e, 520f. These are records 520e, 520f corresponding to user-created guidelines 320e, 320f that will be discussed in greater detail below.

In some embodiments, guideline records 520 may not include a type field 546 for distinguishing between “border” guidelines (e.g., 520a, 520b, 520c, 520d) and “user-created”guidelines (e.g., 520e, 5200. In such case, there may be no “border” guideline records 520a, 520b, 520c, 520d stored in graphical elements database 162, and all guideline records 520 can refer to “user-created” guidelines (e.g., 520e, 520f).

In such embodiment, the placement module 186 may be configured to implicitly recognize border guidelines 320a, 320b, 320c, 320d corresponding to each of the top, bottom, left and right borders of the canvas 170. That is, if a graphical element border 962 (as shown in FIG. 9) of a graphical elements database 162 is linked to a border guideline (e.g., 320a, 320b, 320c, 320d), the placement module 186 may store an empty or NULL value in the guideline identifier field 626 of the corresponding graphical element record 692 (as shown in FIG. 6A) to indicate that no “user-created” guideline (e.g., 320e, 320f) is linked to. When a canvas 170 is subsequently resized, the configuration module 138 can interpret the absence of a guideline identifier 540 in field 626 (as shown in FIG. 6A) as indicating that the linked top, bottom, left or right element border 962 (as shown in FIG. 9) of the graphical element 192 is linked to the respective top, bottom, left or right border guideline (e.g., 320a, 320b, 320c, 320d) of the canvas 170. That is, a left border 962 of a graphical element 192 would be assumed to be linked to the guideline 320c coincident with the left border of the canvas 170, and similar assumptions would be made for the top, bottom and right borders 962 of a graphical element 192 for the respective top, bottom and right border guidelines 320a, 320b and 320d of the canvas 170.

Referring once again to FIG. 3, three graphical elements 192′, 192″, 192′″ are shown having been placed on canvas 170. Referring simultaneously to FIG. 6A, shown there are schematic illustrations of graphical element records corresponding to the graphical elements 192′, 192″, 192′″, shown generally as 692a and stored in graphical elements database 162. As with the other records shown, these properties may be loaded into memory when the designer module 132 or the viewer module 134 is in use, and may be written to the graphical elements database 162 when a dashboard design and layout is saved. Each record 692 may have: fields 620 for indicating the position and size of the graphical element 192, fields 622 for indicating whether the borders of the graphical elements 192 are linked to guidelines 320, fields 624 for indicating the distance from the guideline 320 (if the graphical element 192 is linked) and fields 626 for indicating the identifier of the guideline 320 that the borders 962 of the graphical element 192 are linked to (if applicable). Each record 692 may also be provided with an identifier 640 that is unique to the design of the canvas 170.

The first set of fields 620 relate to the position and size of each graphical element 192. The indicated fields store the Top, Left, Width and Height properties of a graphical element 192, based on a Cartesian coordinate system in which the origin is in the top-left corner of the canvas, with x-values increasing to the right, and y-values increasing downward. As such, these fields 620 store the bounding rectangle of a graphical element 192 (also referred to herein as the element borders 962 of a graphical element 192), the bounding rectangle of a graphical element 192 being the smallest rectangle that can wholly contain the element.

For example, examining for the text box graphical element 192′″ on FIG. 3, it can be seen that its placement is close to the top left hand corner of the canvas 170, and that it has a wide, but short bounding rectangle. Such position and size is reflected in the text box graphical element record 692′″: the Top and Left fields are at 20 units respectively, and the text box graphical element 192′″ is 220 units wide, but only 70 units tall. It will be understood that the units are device-independent units, and are provided for illustrative purposes only; other suitable units for indicating distance on a display may also be used.

The latter three sets of fields 622, 624, 626 will be discussed in greater detail below when discussing the linking of graphical element borders 962 to guidelines 320 (in the context of FIG. 9). Also, FIGS. 6B and 6C schematically illustrate the same graphical element records 692b, 692c as is in FIG. 6A, but at subsequent times, when the canvas 170 has been resized.

To illustrate the operation of the system of the current disclosure, an example including the linking of graphical elements 192 to guidelines 320, and the effect such linking has on the subsequent viewing and resizing of the canvas 170 will now be discussed.

### Linking Graphical Elements to Guidelines

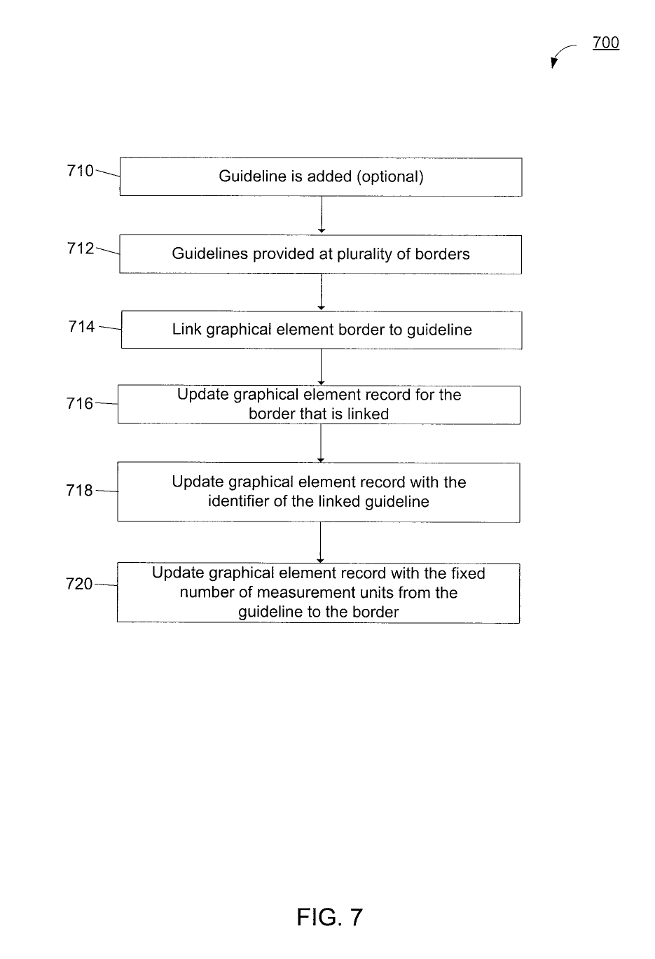

Referring to FIG. 7, therein illustrated is a flowchart of the sequence of steps for linking a graphical element border to a guideline, referred to generally as 700.

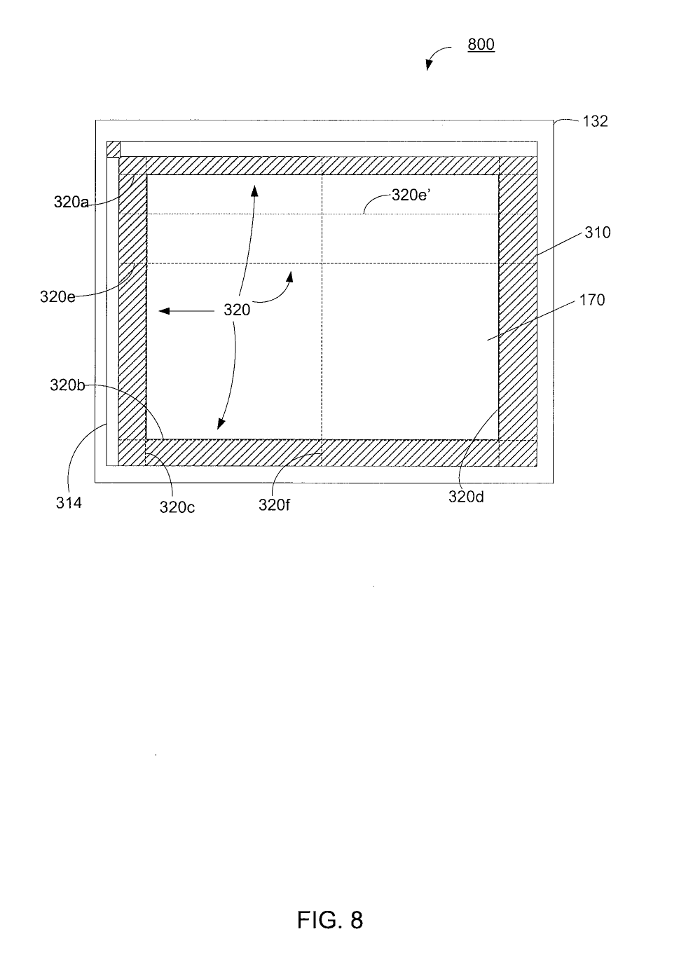

When using the designer module 132, a graphic designer may optionally initiate a drag-and-drop operation from the ruler 312, 314 to add a user-created guideline 320 (Block 710). Referring to FIG. 8, shown there is an example screenshot of adding a user-created guideline 320 to the canvas 170, referred to generally as 800. After initiating a drag-and-drop operation from the ruler 312, a drag line 320e′ may appear to assist the graphic designer in indicating where the desired guideline 320 is to be placed. Once the location is selected, the guideline 320e is shown as being fixed relative to the canvas 170. The example horizontal guideline 320e is placed at the 33% position (indicating that it is 33% of the way down the height of the canvas 170 from the top fixed border guideline 320a). Referring briefly to FIG. 5, a corresponding guideline record 520e is shown, where the orientation field 542 indicates it is a “horizontal” guideline, a position field 544 indicates that it is at the “33%” position, and the type field 546 indicates that it is a “user-created” guideline. Also, it should be noted that another user-created guideline 320f has been added. This user-created guideline is a vertical guideline that is placed at the “50%” position (i.e., it always remains at half the width of the canvas 170, no matter how the canvas 170 is resized). The guideline record 520f (shown in FIG. 5) corresponds to guideline 320f. The orientation field 542 indicates that it is a vertical guideline, the position field 544 indicates that it is at 50% and the type field 546 indicates that it is “user-created”.

Additional or alternative to user-created guidelines 320e, 320f, guidelines 320 may be provided at a plurality of the canvas 170 borders (Block 712). As discussed above in relation to FIG. 3, these may be guidelines 320 that are coincident with the top, left, right and bottom borders of the canvas 170. The graphic designer may select either a user-created guideline 320e, 320f, or a fixed border guidelines, e.g., 320a, 320b, 320c and 320d, for linking to a graphical element border 962.

A first element border 962 of a graphical element 192 may then be linked to a first guideline (Block 714). Referring briefly to FIG. 9, illustrated there is an example of such an operation, shown generally as 900. For illustrative purposes, only the canvas 170 and the corresponding graphical elements 192 are shown. As in FIG. 3, there is a text box graphical element 192′″, a bar chart graphical element 192′ and a pie chart graphical element 192″.

When the bar chart graphical element 192′ is selected on the canvas 170, a selection border 930 appears around the element. The selection border 930 represents the bounding rectangle of the bar chart graphical element 192′. Attached to each side of the selection border 930 is a small square area known as a pin point. A pin point is used to pin or link (i.e., anchor) the corresponding side (i.e., an element border 962) of a graphical element 192′ to a parallel guideline 320. Graphical elements 192 can be configured to have up to four pin points. In the example illustrated, the bar chart graphical element 192′ has pin points 902, 904, 906, and 908.

When the top element border 962 of the graphical element 192′ is pinned to a first guideline 320a, a corresponding pin line 912 connects the pin point 902 to the guideline 320a, forming a connection point 922. This pin line is typically oriented perpendicular to both the guideline 320a and the linked top element border 962. The length of the pin line 912 represents a fixed number of measurement units between the linked top element border 962 and the top fixed border guideline 320a. In this instance, the first guideline 320a was a fixed border guideline 320a fixed to a border of the canvas 170. When the canvas 170 is viewed using the viewer module 134 or in the designer module 132, this distance remains fixed in the number of measurement units even as the canvas 170 is resized. A pin line effectively represents a constraint on the position and/or size of a graphical element as the display surface is resized. In this way, it is a first fixed link of a fixed number of measurement units that links a first element border to the first guideline 320a, the measurement units being, in one embodiment, the device-independent units stored in the graphical element records 692 discussed in FIG. 6A. This procedure may be repeated for linking one or more additional element borders 962 to one or more additional guidelines 320.

A pin line 912, 914, 916, 918 is a visual indicator that indicates that an element border 962 is linked, and identifies the guideline 320 to which it is linked. Pin points 902, 904, 906, 908 and pin lines 912, 914, 916, 918 are visible only at design-time when designer module 132 is used. In addition, in some embodiments, the pin points 902, 904, 906, 908 and pin lines 912, 914, 916, 918 (if any) for a graphical element 192 may be only visible when that graphical element 192 is selected at design-time.

While pin points 902, 904 and 906 are pinned to fixed border guidelines, 320a, 320d and 320b respectively, pin point 908 is pinned to a user-created guideline 320f. As noted above, this user-created guideline 320f is defined as a percentage of the entire width of the canvas 170. Specifically, guideline 320f is configured to remain at 50% of the horizontal width no matter how the canvas 170 is resized. Nevertheless, the distance between this guideline 320f and the left border 962 of the bar chart graphical element 192′ remains the same because pinpoint 908 has been linked to guideline 320f. In this way, the linking of a pin point 908 of a graphical element 192′ to a user-created guideline 320 allows the combination of both relative (the guideline 320 has a relative position −50% of the width of the canvas 170) and absolute (an absolute number of measurement units from the guideline 320) positioning of a graphical element 192.

Referring again briefly to FIG. 1, when linking graphical elements 192 to guidelines 320, the placement module 186 of the designer module 132 receives input from the graphic designer and sends a message to the configuration module 138 to indicate which graphical elements 192 are linked to which guidelines 320. The configuration module 138 then sends a message to the visualization module 150 of application server 106 through application services 142 in client API 140. The designer services 156 in visualization module 150 receives this message and proceeds to update the corresponding graphical element record 692 in graphical elements database 162.

Referring to FIG. 6A, therein illustrated is an example of such graphical element records 692 after a linking operation. While the fields 620 related to the bounding rectangle of a graphical element 192 has been described above, the remaining fields will now be explained. They are fields 622 for indicating whether the borders of the graphical elements 192 are linked to guidelines 320, fields 624 for indicating the distance from the guideline 320 (if the graphical element 192 is linked) and fields 626 for indicating the identifier of the guideline 320 that the borders 962 of the graphical element 192 are linked to (if applicable).

The configuration module 138 may need to update the graphical element records 692 to indicate which borders have been linked to a guideline (Block 716). With regards to fields 622, boolean-valued properties TopPin, RightPin, BottomPin and LeftPin indicate whether the corresponding top, right, bottom and left sides of the graphical element 192 are linked or not. If a field is set to “TRUE”, then it is linked. If it is set to “FALSE”, it is not.

For a bar chart graphical element record 692′ corresponding to the bar chart graphical element 192′ being linked to guidelines 320a, 320d, 320b and 320f in FIG. 9, the fields 622 related to whether the borders are linked have all been updated to “TRUE”.

The configuration module 138 may also be configured to update the graphical element records 692 with the ID of the guideline 320 that each of the borders are linked to (Block 718). Referring again to FIG. 6A, the identifier-based fields 626 TopGuideline, RightGuideline, BottomGuideline and LeftGuideline identify the specific guideline 320 that the corresponding side of the graphical element 192 may be linked to or pinned against. It can be seen that for the bar chart graphical element record 692′ shown as being linked to guidelines 320 in FIG. 9, the fields 626 related to the identifiers 540 of the guidelines 320 have been updated with the identifiers 540 of the respective linked guidelines.

Examining the fields 626 related to the identifier 540 of the guidelines 320 to which each of the borders 962 are pinned, it can be seen that the top, right, bottom and left element borders 962 are pinned to the guidelines 320a, 320d, 320b and 320f with ID “GUID1”, “GUID4”, “GUID2” and “GUID6” respectively. Referring briefly also to FIG. 5, it can be seen that the guidelines 320a, 320d and 320b with “GUID1”, “GUID4” and “GUID2” are the fixed border guidelines corresponding to the top, right and bottom borders (records 520a, 520d, 520b) of the canvas 170 respectively. Further, it can be seen that the guideline record 520f with “GUID6” is the user-created vertical guideline set at half the width of the canvas 170.

The configuration module 138 may then update the graphical element record 692 with the fixed number of measurement units from the guidelines 320 to the border 962 of the graphical element 192 (Block 720). Referring again to FIG. 6A, the fields 624 indicate the fixed distances a linked border 962 is from the corresponding guidelines 320. That is, the Margin.Top, Margin.Right, Margin.Bottom and Margin.Left fields specify the distance from the top, right, bottom and left borders 962 are from their respective linked guidelines 320. It can be seen that for the bar chart graphical element record 692′ shown as being linked to guidelines in FIG. 9, the fields 624 related to the fixed number of measurement units the border 962 of the graphical element 192 is away from the guidelines 320 has been updated to reflect what the graphic designer indicated to the designer module 132. That is, the top, right and bottom borders 962 are to be “20 units” from the linked top, right and bottom guidelines, whereas the left border 962 is to be “10 units” from the linked left guideline.

After these three sets of data have been updated in a graphical element record 692′, the graphical element 192 has been linked to a guideline 320.

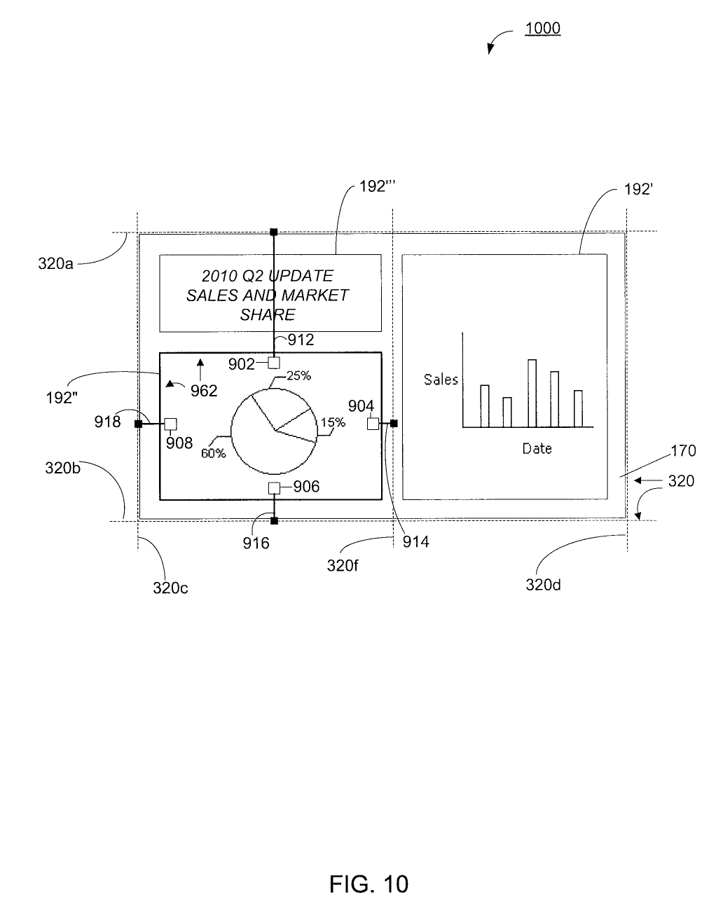

Referring to FIG. 10, shown there generally as 1000 is an additional example screen shot showing a pie chart graphical element 192″ that is highlighted on the canvas 170 (e.g., by a graphic designer selecting the pie chart graphic element 192″ on a user interface 130) and is being linked to guidelines 320a, 320b, 320c, and 320f on a canvas 170. While not discussed in great detail, a similar process as is described above with respect to the bar chart graphical element 192′ may take place to link the borders 962 of the pie chart graphical element 192″ to its respective guidelines 320.

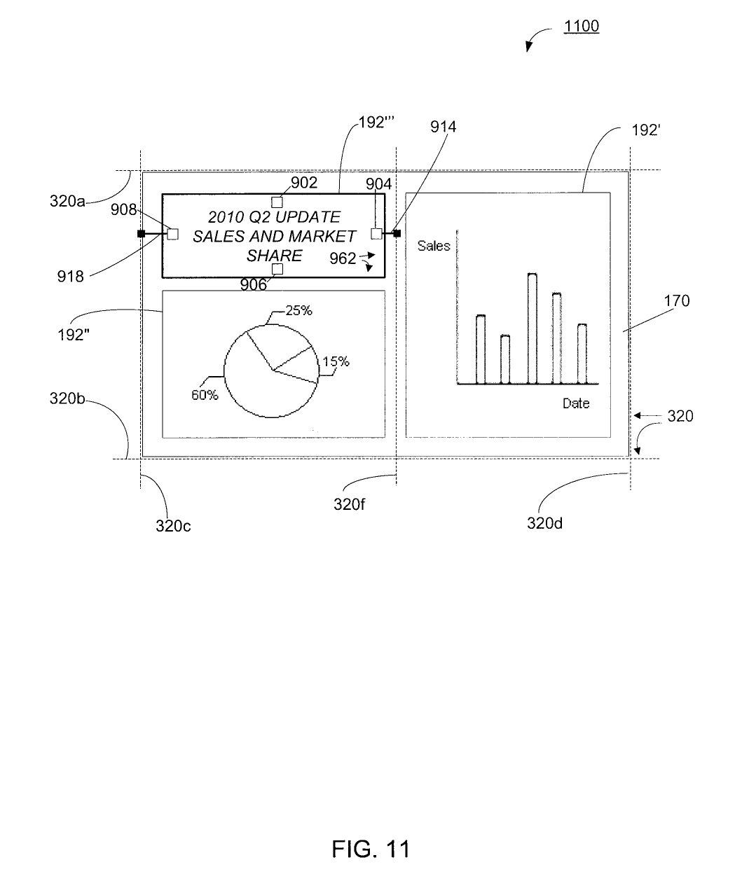

Referring to FIG. 11, this is an example screen shot showing a text box graphical element 192′″ that is highlighted on the canvas 170 and linked to guidelines 320c and 320f on a canvas 170. Notably, text box graphical element 192′″ is only linked to vertical guidelines. That is, although the left and right borders 962 will remain a fixed distance from the left fixed border guideline 320c and the center vertical guideline 320f respectively, there is no constraint on the top and bottom borders 962, and thus their positions will not be modified upon a reconfiguration or resizing of the canvas 170. However, in other embodiments, unlinked element borders 962 may be configured to scale relative to the borders when the canvas 170 is resized.

### Effect of Resizing the Canvas on Graphical Elements

Although the system of the present disclosure can be configured to update the appearance of graphical elements 192 when used by both a designer module 132 and a viewer module 134, the examples described below will be in the context of the viewer module 134. The examples are provided for illustration purposes, and should not be construed as limiting the ways in which the system of the present disclosure can be practiced.

Referring again to FIG. 1, when a completed dashboard design is viewed, the system 100 of the present disclosure may be configured to communicate the position of the element borders 962 of graphical elements 192 to the drawing application 120 to render the graphical elements 192. That is, configuration module 138 may be configured to retrieve data about what to display so as to be able to communicate it to the renderer 176 of the viewer module 134 of the drawing application 120 for rendering at least one graphical element 192 on the completed dashboard design on visualization terminal 102. Configuration module 138 may send messages to visualization module 150 through client API 140 and network 110. The application services 152 of visualization module 150 may, in response, be configured to retrieve graphical element records 692, canvas records 470 and guideline records 520 from the graphical elements database 162 and relay them back to the configuration module 138. The configuration module 138, may then use the data retrieved to perform the operations described below in determining the position of the element borders 962, i.e., calculating the new bounding rectangles for the graphical elements 192 affected by a resizing of the canvas 170.

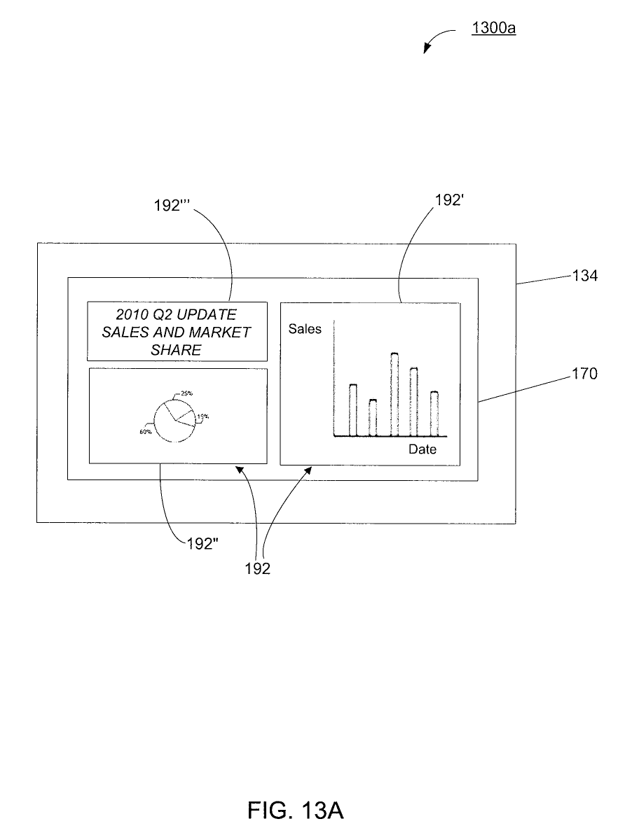

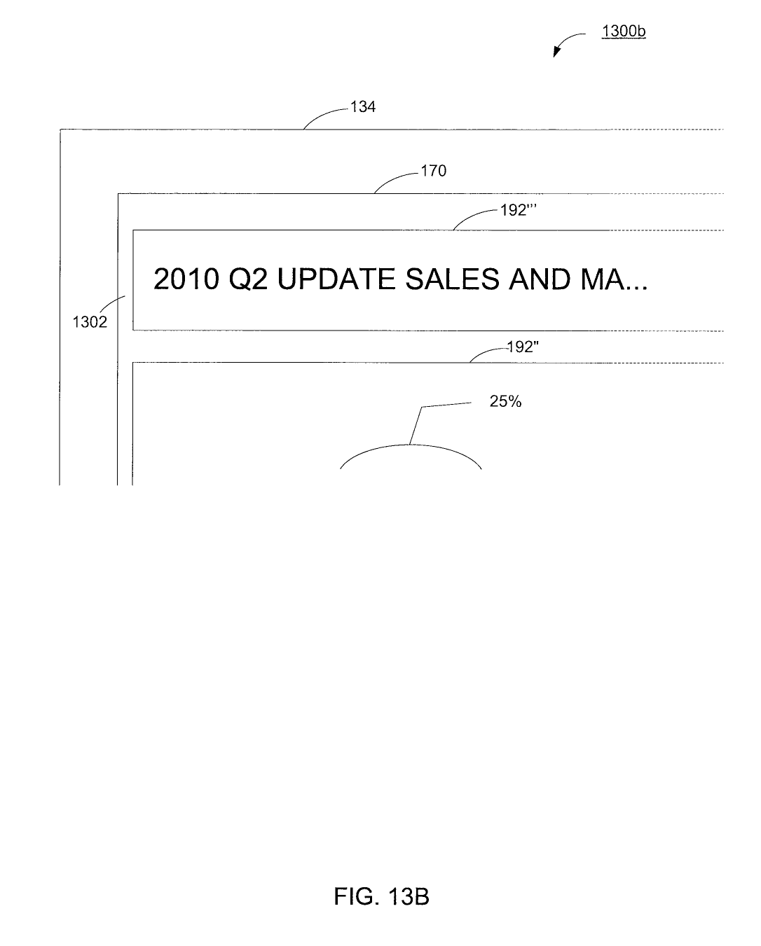

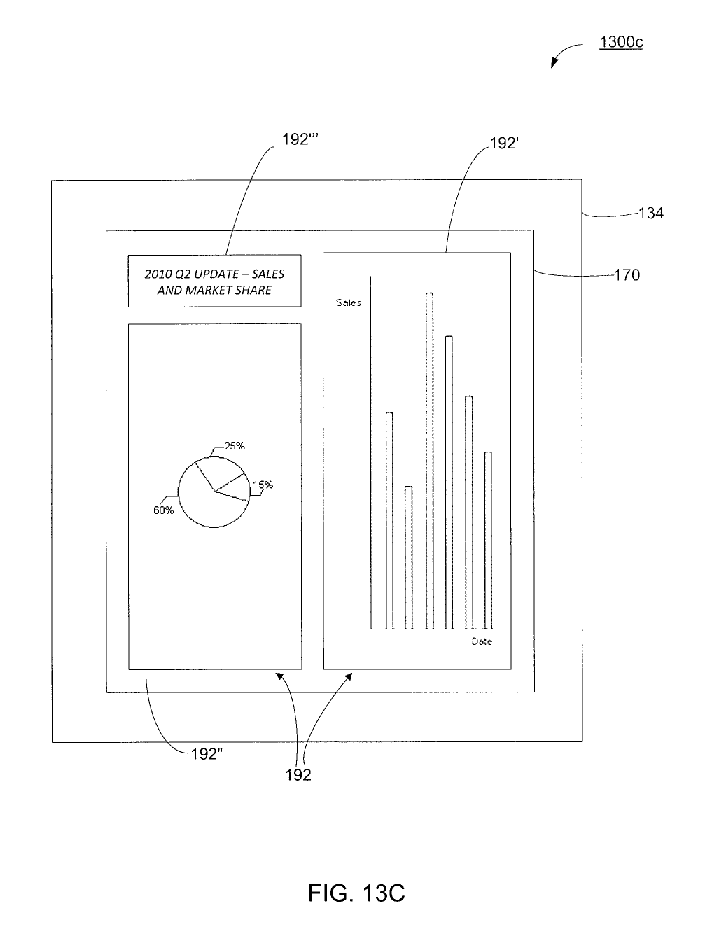

Referring to FIG. 13A, and continuing on with the example described above with respect to the linking of graphical elements 192 to guidelines 320, shown there is an example screenshot, shown generally as 1300a, of a completed dashboard design as rendered by renderer 176 in viewer module 134. The canvas 170 is shown in its original size, and all the graphical elements 192′, 192″ and 192′″ can be viewed on the canvas 170. The graphical elements data present in the graphical elements database 162 includes the canvas record 470 shown in FIG. 4A, the guideline records 520 shown in FIG. 5 and the graphical element records 692 shown in FIG. 6A.

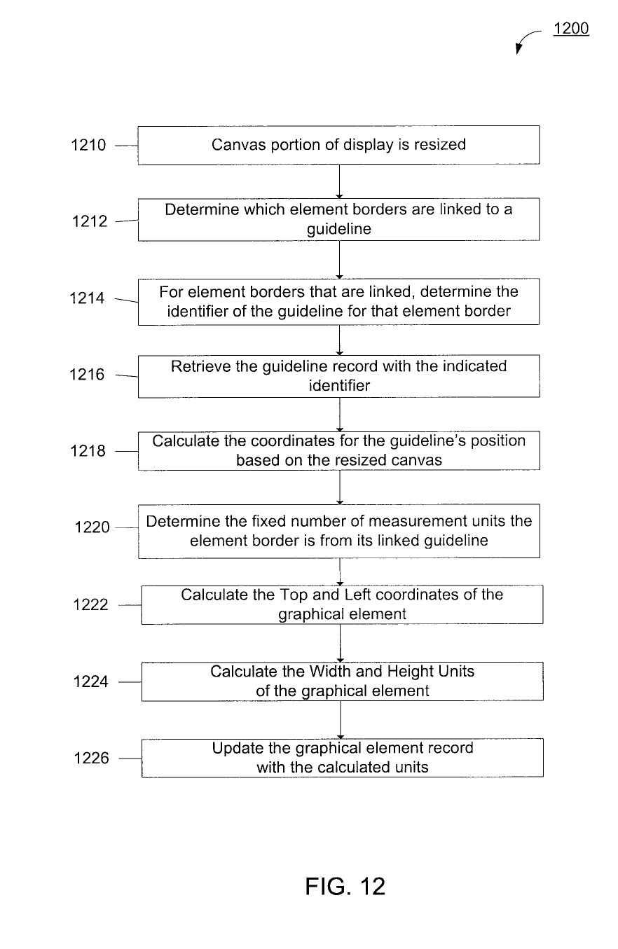

Referring to FIG. 12, therein illustrated is a flowchart of the sequence of events that takes place when a canvas 170 portion of a display is reconfigured or resized after the linking of the borders 962 of a graphical element 192 to guidelines 320, referred to generally as 1200. These events describe the determination of the position of the linked element borders 962 of graphical elements 192 upon a reconfiguration or resizing of a canvas 170. For the purposes of discussion below, only the calculations for the text box graphical element 192′″ and the bar chart graphical elements 192′ will be discussed. However, it will be understood that similar calculations can be performed for other graphical elements 192, e.g., the pie chart graphical element 192″.

When viewing a completed dashboard design, a business executive may first cause the resizing of the canvas 170, changing the width and/or height of the canvas 170 (Block 1210). This may be done for numerous reasons. For example, the business executive using the viewer module 134 may be viewing KPIs from the live business data 194 on a business data server 104 to derive business insights from the metrics shown. He or she may be quite busy and may be accessing dashboards (or canvas 170) from different devices with varying screen sizes. The dashboard may thus need to be resized to fit the appropriate screen size of the device display on which it is shown. Alternatively, the canvas 170/dashboard may be resized to free up space on the display for other uses in a multiple window environment.

Referring briefly to FIG. 4B, shown there generally as 470b are the updated dimensions of a canvas record 470 after the canvas 170 shown in FIG. 13A has been resized. Referring simultaneously to the canvas record 470 shown in FIG. 4A, it can be seen that both the width field 472 and the height field 474 have been doubled. The Width property 472 of the canvas 170 has been doubled to 1000 units. The Height property 474 of the canvas 170 has been doubled to 600 units. The Re-Size Mode property 476 is unchanged and is set to “Resize”.

When redrawing a graphical element 192 contained in the canvas 170, the configuration module 138 (as shown in FIG. 1) determines which element borders 962 are linked to a guideline 320 using the graphical element records 692 retrieved from the visualization module 150 (as shown in FIG. 1) (Block 1212). Referring briefly to FIG. 6A, examining the text box graphical element record 692′″, the configuration module 138 would look up the fields 622 related to guideline 320 linking and determine that the RightPin and LeftPin fields are set to “TRUE”, while the TopPin and BottomPin fields are set to “FALSE”. This indicates that the text box graphical element 192′″ only has its left and right borders linked to a guideline 320. Similarly, it can be seen that for the bar chart graphical element record 692′ corresponding to the bar chart graphical element 192′, the fields indicating whether the borders of the graphical element 192′ are linked are all set to “TRUE”.

For each border that is linked, the configuration module 138 determines the ID of the guideline 320 for that border using the graphical element records 692 retrieved from the visualization module 150 (as shown in FIG. 1) (Block 1214). Referring again to FIG. 6A, for the text box graphical element record 692′″, the configuration module 138 looks up the identifier 540 of the guidelines to which the left and right borders of the text box is linked. Examining the LeftGuideline and RightGuideline fields in the fields 626 relating to the identifier 540 of the guidelines 320 to which the borders of the graphical element 192′″ are linked, it can be seen that they are linked to guidelines with “GUID3” and “GUID6” respectively. Similarly, examining the same fields 626 for the bar chart graphical element 692′, it can be seen that the TopGuideline, RightGuideline, BottomGuideline and LeftGuideline are linked to guidelines with “GUID1”, “GUID4”, “GUID2” and “GUID6” respectively.

The configuration module 138 then retrieves the guideline records 520 from the graphical elements database 162 for the guideline identifiers 540 it found in block 1214 (Block 1216). Referring briefly to FIG. 5, the configuration module 138 can determine that for the text box graphical element 192′″, the guideline record 520f with “GUID6” is a user-created vertical guideline set at 50% of the horizontal width, and that the guideline record with “GUID3” is a fixed vertical border guideline set at 0%. Similarly, for the bar chart graphical element 692′, the configuration module 138 can determine that the guidelines records 520a, 520d, 520b and 520f with IDs “GUID1”, “GUID4”, “GUID2” and “GUID6” respectively, are the guidelines 320a, 320d and 320b coincident with the top, right and bottom borders of the canvas 170 respectively, along with the vertical guideline 320f set at half the width of the canvas 170.

Having determined the relative positions of the guidelines 320 to which the graphical element borders 962 are linked, the configuration module 138 calculates the coordinates for the guideline 320's absolute position based on the resized canvas 170 (Block 1218). That is, upon the reconfiguration of the canvas 170, the guidelines 320 may be repositioned in an absolute sense in view of their relative position (i.e., the percentage value) as it relates to the resized canvas 170.

For fixed border guidelines 320, the position is set to “0” for guidelines set at 0%, the full width of the canvas 170 for vertical guidelines set at 100%, and the full height of the canvas 170 for horizontal guidelines set at 100%. The position of the vertical guideline with GUID3 is thus “0” because it is set at 0%, for example.

For user-created guidelines 320 set at a percentage value, the position of the guideline 320 is the indicated percentage of the resized width or height of the canvas 170, depending on whether it is a vertical or horizontal guideline respectively. Referring briefly to FIG. 4B, the resized width of the canvas 170 is “1000 units”. The position of the vertical guideline 320f with “GUIDE” is thus 50% of “1000”, which is determined to be “500 units” (1000×50%=500). Thus, the vertical guideline 320f has been repositioned as it relates to its absolute coordinates (i.e., its new absolute position is “500 units”), but its relative position has not changed (it is still 50% of the total width of the resized canvas 170).

The configuration module 138 may then determine the fixed number of measurement units the element border 962 is from its linked guideline 320 using the graphical element records 692 retrieved from the graphical elements database 162 (Block 1220). Referring briefly to FIG. 6B, for the text box graphical element 692′″, the Margin.Right and Margin.Left fields in fields 624 related to the fixed distance a border 962 of a graphical element 192 is to appear from a guideline 320 indicate that the right and left borders 962 of the text box graphical element 192′″ are to appear “10 units” and “20 units” from the respective right and left guidelines 320. Similarly, for the bar chart graphical element 692′, the Margin.Top, Margin.Right, Margin.Bottom and Margin.Left fields 624 indicate that the distances from the respective guidelines 320 are “20 units”, “20 units”, “20 units” and “10 units” respectively.

Having determined the positions of the guidelines 320 and the fixed distances the borders 962 are to appear from the linked guidelines 320, the configuration module 138 can now proceed to determine the positioning of the element borders 962 corresponding to the guidelines 320 and link. To do so, it must determine the position and size coordinates of the element borders 962 of the resized graphical element 192. The configuration module 138 can first determine the Top and Left coordinates (Block 1222), which are based on based on the top and left guideline's 320 updated position and the respective fixed number of units from these guidelines 320 (as determined in Block 1220).

Reference will now be made to FIG. 6B for graphical element records 692′″, 692′ after a canvas 170 has been resized by doubling its width and height. For the text box graphical element record 692′″, the Left coordinate in fields 620 is set to “20 units”. This is the Left position of the left guideline 320c (“0 units”) plus the number of fixed units the border 962 is to appear away from the guideline 320c (“20 units”). The Top coordinate is set to the position of “20 units” because the top and bottom borders 962 of the graphical element 192 are not linked to any guideline 320 and, as noted above, the top position will not change. Similarly, for the bar chart graphical element record 692′, the Top field is set to “20 units”, which is the position of the top guideline 320a (“0 units”) plus the number of fixed units the border 962 is to appear away from the guideline 320a (“20 units”). The Left coordinate is set to the position of “510 units”, which is the position of the left guideline 320f (“500 units”, that is half the “1000 units” from the resized canvas 170, as calculated in Block 1218) plus number of fixed units the border 962 is to appear away from the guideline 320f (“10 units”, as determined in Block 1220).

The configuration module 138 then calculates the Width and Height units of the graphical element 192 (Block 1224). This is based on the calculated Top and Left coordinates from block 1222, their right and bottom guidelines' updated position and their respective fixed number of units from their guidelines 320. Referring again to FIG. 6B, the Width of the text box graphical element 192′″ is set to the position of the right guideline 320f (“500 units”, as determined in Block 1218) minus the Left coordinate (“20 units”, as determined in Block 1222), and further subtracting the distance the right border 962 is to appear from the right guideline 320f (“10 units”, as determined in Block 1220). The result is “470 units”, as indicated by the Width field of the set of fields 620 related to position and sizing. The Height coordinate is unchanged because the top and bottom borders 962 are not both linked to guidelines 320. Similarly, for the bar chart graphical element record 692′, the Width is set to the position of the right guideline 320d (“1000 units”, as determined in Block 1218) minus the Left coordinate (“510 units”, as determined in Block 1222), and further subtracting the distance the right border 962 is to appear from the right guideline 320d (“20 units”, as determined in Block 1220). The result is “470 units”, as indicated by the Width field of the set of fields 620 related to position and sizing. Correspondingly, the Height field is set to the position of the bottom guideline 320b (“600 units”, as determined in Block 1218) minus the Top coordinate (“20 units”, as determined in Block 1222), and further subtracting the distance the bottom border 962 is to appear from the bottom guideline 320b (“20 units”, as determined in Block 1220). The result is “560 units”, as indicated by the Height field of the set of fields 620 related to position and sizing.

Once the new position and sizing coordinates have been calculated, they are recorded in the graphical element records 692 (Block 1226). These new absolute position and size fields 620 are then read by the renderer 176 of viewer module 134 (as shown in FIG. 1) to reflect the new size and position of each graphical element 192 when rendering the dashboard containing the resized canvas 170.

The blocks 1212-1226 described above may be repeated for each of the graphical elements 192 on the resized canvas 170.

Referring to FIG. 13B, shown there is a magnified or zoomed-in view of a dashboard design of FIG. 13A in which canvas 170 has been resized by doubling its height and width, shown generally as 1300b. The illustration shows the top left hand corner of the example screenshot shown in FIG. 13A, illustrating the text box graphical element 192′″ and the pie chart graphical element 192″ on the canvas 170 of the viewer window provided by the viewer module 134. Notably, because the left and right borders 962 of the text box graphical element 192′″ was linked to guidelines 320c, 320f (as shown in FIG. 11), it has “stretched out” horizontally so as to be able to include all of the text formerly on three lines on one line. However, the distance 1302 between the left border 962 of the text box graphical element 192′ and the left border of the canvas 170 has not changed. Similarly, when examining the pie chart graphical element 192″, it may now appear proportionately closer to the top border of the canvas 170 (when compared to the canvas 170 shown in FIG. 13A) to take up a larger proportion of the vertical height of the canvas 170 because its borders 962 were stretched to fit the larger canvas size without the distance between the top border 962 of the pie chart graphical element 192″ and the top border of the canvas 170 changing.

Referring now simultaneously to FIGS. 4C, 6C and 13C, shown there is another example of a resizing of the canvas 170 shown originally in FIG. 13A (the canvas record 470 for which is shown in FIG. 4A, and the original graphical element records 692 for which are shown in FIG. 6A). In light of the discussion above with regards to how the resizing of graphical elements 192 can be performed, these figures will be discussed only by referring to the data present in the various records 470c, 692c that are retrieved from graphical elements database 162 (as shown in FIG. 1) after the canvas 170 has been resized.

Referring to FIG. 13C, therein illustrated is an alternate example screen shot where the canvas 170 is resized from that which is shown in FIG. 13A. In this example and referring also to FIG. 4C, the canvas record 470, shown generally as 470c shows a doubling in height to 600 units, and an increase in width by 20 units from the canvas record values in FIG. 4A. As can be seen in the illustration in FIG. 13C, the bounding rectangles of the pie chart graphical element 192″ and the bar chart graphical element 192′ have scaled to fit the resized canvas 170 while maintaining their fixed distances from the guidelines 320 to which their element borders 962 have been linked. Similarly, the text box graphical element 192′″ has scaled and maintained its distance from the left border and the middle guideline 320f (as shown in FIG. 11). Since the right element border 962 of the text box graphic element 192′″ was pinned to the middle vertical guideline 320f, the text box 192′″ has stretched out horizontally, allowing for text that required three lines (i.e., as was illustrated in FIG. 13A) to fit on two lines. It should be understood that the rendering of graphical elements 192 can be performed by the renderer 176 in the viewer module 134. That is, the renderer 176 redraws the contents of a resized graphical element 192 once the position and size coordinates (i.e., the bounding rectangle) have been determined. As noted below, the exact details of how the graphical element 192 is to be rendered may be unrelated to the bounding rectangle, but instead may be determined by the graphical element 192 itself.

Referring to FIG. 6C, therein illustrated is a schematic illustration of the graphical element records 692 after the resizing of the canvas 170 illustrated in FIG. 13C, shown generally as 692c. It can be seen that the positional coordinates and sizing fields 620 in the graphical elements records 692′, 692″ and 692′″ corresponding to the graphical elements 192′, 192″ and 192′″ have been updated from the values present in FIG. 6A. For example, in examining the graphical element record 692′ corresponding to the bar chart graphical element 192′, it can be seen that the Left coordinate for the graphical element 192 is placed at “270 units” (that is, the Margin.Left field's “10 units” from “260 units”, which is the position of the “50%” vertical guideline 320f (shown in FIG. 11) to which the left border 962 of the graphical element 192′ is linked; the “260 units” being half of the new width, “520 units”, of the canvas 170 shown in FIG. 4C.

The Width of the graphical element record 692′ is also set to “230 units”, which places the right element border 962 of the bar chart graphical element 192′ at “500 units” (the Left field “270 units” plus the Width field “230 units” equals “500 units”), which is “20 units” to the left of the right fixed border guideline 320d at “520 units” (shown in FIG. 11), as is required by the pinning of the right element border 962 of the graphical element 192 to the right fixed border guideline 320d.

Notably, in some embodiments, only the position and size of the graphical element 192 is modified by the configuration module 138 at display-time when a graphical element 192 is pinned or linked to a guideline 320. That is, how the visual content of a graphical element 192 is affected in response to a change in the position and size fields 620 may be determined by the graphical element 192 itself. For example, the pie chart 192″ from FIG. 13A can be configured to render its pie sections as part of an overall circular shape, regardless of the aspect ratio of its bounding rectangle or selection border 930 (see e.g., FIG. 13C still shows the pie chart graphical element 192″ as still having a circular pie shape). Alternatively, the bar chart graphical element 192′ from FIG. 13A can be configured to adjust the aspect ratio of its bar sections in order to fill up the available space within its bounding rectangle or selection border 930.

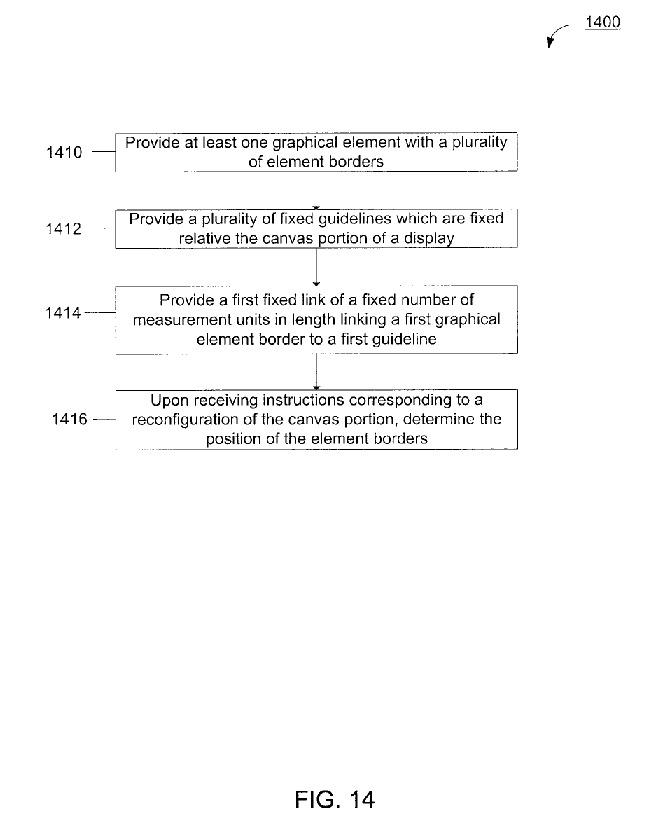

Referring to FIG. 14, therein illustrated are the steps of a method for determining positioning and relative sizing of at least one graphical element 192 to be rendered on a canvas 170 portion of a display, referred to generally as 1400. As discussed above with reference to FIG. 1, the canvas 170 portion of a display may reside on a configuration module 138 so that it may be used by a designer module 132 or a viewer module 134 of a user interface 130 for a drawing application 120.

At block 1410, at least one graphical element 192 having a plurality of element borders 962 is provided. As discussed above, the at least one graphical elements 192 may be a graphical representation of business data 194 for assisting business executives with visualizing and understanding their data. The element borders 962 form the boundary in which the graphical elements 192 render themselves. They may be altered depending on layout chosen through use of the designer module 132.

At block 1412, a plurality of fixed guidelines 320 that are fixed relative to the canvas 170 portion of the display are provided. Vertical and horizontal guidelines 320 are set at a percentage of the width or height of the canvas 170 respectively. Typically, at least one horizontal and one vertical guideline 320 are provided to overlap/correspond to a horizontal and vertical border on the canvas 170. The fixed relative sizing allows for the position of the guideline 320 (relative to the size of the canvas 170) to remain the same no matter how the canvas 170 is resized. That is, its relative position may be fixed, while its absolute position changes.

At block 1414, a first fixed link of a fixed number of measurement units in length linking a first graphical element border 962 to a first guideline 320 is provided. As discussed above, a link between a graphical element border 962 and a guideline 320 may be achieved on user interface 130 by dragging a pin point of a displayed graphical element 192 in the designer window of a designer module 132 to a guideline 320 so that a pin line is formed between the two. The distance between the border and the guideline 320 corresponds to the fixed number of measurement units for the link.

At block 1416, when receiving instructions corresponding to a reconfiguration of the canvas portion 170, the position of the element borders is determined. As discussed above, the position and sizing of graphical elements 192 are calculated using information stored in the graphical elements database 162. For any given graphical element 192 on a canvas 170, the configuration system 138 first looks up which of its borders are linked to guidelines. The resized position of the linked guidelines 320 are then determined. From there, the ultimate coordinates and sizing of the graphical element 192 are determined, further taking into account the fixed distance each of the element borders 962 is to appear from guidelines 320.

It will be understood by persons skilled in the art that the size, layout and type of graphical elements 192 are provided by way of example only. It will be understood by persons skilled in the art that variations are possible in variant implementations and embodiments. Such variations include, but are not limited to, variations in the connectivity amongst described components, the sequence of execution by described components and the organization of described components.

The steps of a method in accordance with any of the embodiments described herein may be provided as executable software instructions stored on computer-readable media, which may include transmission-type media. Such steps may not be required to be performed in any particular order, whether or not such steps are described in claims or otherwise in numbered or lettered paragraphs.

The invention has been described with regard to a number of embodiments. However, it will be understood by persons skilled in the art that other variants and modifications may be made without departing from the scope of the invention as defined in the claims appended hereto.

1. A configuration system for determining positioning and relative sizing of at least one graphical element to be rendered on a canvas portion of a display, the at least one graphical element having a plurality of element borders, the system comprising:
a) a plurality of fixed guidelines which are fixed relative to the canvas portion;
b) wherein the fixed guidelines comprise a first guideline;
c) a first fixed link of a fixed number of measurement units in length linking a first element border to the first guideline;
d) wherein the system is configured, upon the reconfiguration of the canvas portion, to determine the position of the element borders.

2. The system of claim 1, further configured to communicate the position of the element borders to a drawing application configured to render the at least one graphical element.

3. The system of claim 1, wherein the fixed guidelines comprise at least one horizontal guideline.

4. The system of claim 3, wherein the at least one horizontal guideline is placed at a point corresponding to a fixed fraction of the height of the canvas portion.

5. The system of claim 1, wherein the fixed guidelines comprise at least one vertical guideline.

6. The system of claim 1, wherein the reconfiguration of the canvas portion comprises repositioning of the first guideline.

7. The system of claim 1, wherein the first guideline comprises a fixed border guideline fixed to a border of the canvas portion.

8. The system of claim 1, wherein the at least one graphical element is selected from the group consisting of a text box, an image, a label, a graph, a chart, a gauge, or a map.

9. The system of claim 1, further comprising a graphical elements database configured to store graphical elements data corresponding to the at least one graphical element.

10. The system of claim 9, wherein the graphical elements data comprises guideline data corresponding to the fixed guidelines.

11. The system of claim 9, wherein the graphical elements data comprises key performance indicator data.

12. A drawing application comprising the configuration system of claim 1.

13. A method of determining positioning and relative sizing of at least one graphical element to be rendered on a canvas portion of a display, the at least one graphical element having a plurality of element borders, the method comprising:
a) providing a plurality of fixed guidelines which are fixed relative to the canvas portion;
b) wherein the fixed guidelines comprise a first guideline;
c) providing a first fixed link of a fixed number of measurement units in length linking a first element border to the first guideline;
d) upon receiving instructions corresponding to a reconfiguration of the canvas portion, determining the position of the element borders.

14. The method of claim 13, wherein determining the position of the element borders comprises determining the position of the fixed guidelines corresponding to the reconfiguration of the canvas portion.

15. The method of claim 13, wherein the position of the first element border is determined to correspond to the first guideline and to the first fixed link.

16. The method of claim 13, further comprising rendering the at least one graphical element.

17. The method of claim 13, wherein the rendering comprises communicating the position of the element borders to a drawing application configured to render the at least one graphical element.

18. The method of claim 13, wherein the first guideline comprises a fixed border guideline fixed to a border of the canvas portion.

19. The method of claim 13, wherein the at least one graphical element is selected from the group consisting of a text box, an image, a label, a graph, a chart, a gauge, or a map.

20. The method of claim 13, wherein the at least one graphical element corresponds to key performance indicator data.
